(19) United States
(12) Patent Application Publication
(10) Pub. No.: US 2011/0040602 A1
(43) Pub. Date: Feb. 17, 2011

(54) METHOD AND SYSTEM FOR FACILITATING AND AGGREGATING SURVEYS AND OPINIONS

(76) Inventor: DANIEL RAMESH KURANI, Manasquan, NJ (US)

Correspondence Address: MALDJIAN & FALLON LLC, 36 BINGHAM AVENUE, RUMSON, NJ, 07760, US

(21) Appl. No.: 12/539,466

(22) Filed: Aug. 11, 2009

(51) Int. Cl. G06Q 30/00; G06F 15/16

(52) U.S. Cl. 705/10; 705/14.19; 709/206; 705/27.1

(57) ABSTRACT

Embodiments of the present invention relate to a method and system for facilitating and aggregating surveys and opinions regarding multimedia data in connection with a purchasable good or service. In one embodiment of the present invention, a method for facilitating and aggregating surveys and opinions comprises receiving at a central server, from a first user, multimedia data associated with a purchasable good/service, associating a set of attributes with the purchasable good/service at the central server, presenting the multimedia data associated with the purchasable good/service and the set of attributes to a second user, receiving feedback reflective of the second user's opinion based on the multimedia data associated with the purchasable good/service and the set of attributes, and displaying the feedback to the first user.

### BACKGROUND

1. Field of the Invention

Embodiments of the present disclosure generally relate to a method and system for facilitating and aggregating surveys and opinions. More specifically, embodiments of the present invention relate to a method and system for facilitating and aggregating surveys and opinions regarding multimedia data in connection with a purchasable good or service.

2. Description of Related Art

As online shopping becomes more popular, consumer demand for increased functionality from shopping tools and assistants drastically increases. Although hundreds of online websites exist for consumers to review products before purchasing, it is often difficult to obtain the source of veracity of the reviews of such products. Thus, a consumer may often be misled by unknown third party opinions, reviews or feedback regarding particular purchasable goods or services.

As such, there is a need in the industry for a method and system for facilitating and aggregating surveys and opinions regarding multimedia data in connection with a purchasable good or services. In addition, there is a need in the industry for an application allowing an individual to query a selected group of friends, family colleagues, and receive aggregated feedback and opinions from the group.

### SUMMARY

Embodiments of the present invention relate to a method and system for facilitating and aggregating surveys and opinions regarding multimedia data in connection with a purchasable good or service. In one embodiment of the present invention, a method for facilitating and aggregating surveys and opinions comprises receiving at a central server, from a first user, multimedia data associated with a purchasable good/service, associating a set of attributes with the purchasable good/service at the central server, presenting the multimedia data associated with the purchasable good/service and the set of attributes to a second user, receiving feedback reflective of the second user's opinion based on the multimedia data associated with the purchasable good/service and the set of attributes, and displaying the feedback to the first user.

In another embodiment of the present invention, a method for facilitating and aggregating surveys and opinions comprises receiving from a first user, image data associated with a purchasable good/service at a central server, receiving a question generated by the first user, associating the question with the purchasable good/service at the central server, presenting the image data associated with the purchasable good/service and the question to a second user, receiving feedback reflective of the second user's opinion based on the image data associated with the purchasable good/service and the question, and displaying the feedback to the first user.

In yet another embodiment of the present invention, a system for facilitating and aggregating surveys and opinions comprises: a central server, accessible via a global computer network comprising a tangible computer readable medium comprising program instructions, wherein the program instructions are computer-executable to implement: receiving from a first user, multimedia data associated with a purchasable good/service at a central server, associating a set of attributes with the purchasable good/service at the central server, presenting the multimedia data associated with the purchasable good/service and the set of attributes to a second user, receiving feedback reflective of the second user's opinion based on the multimedia data associated with the purchasable good/service and the set of attributes, and displaying the feedback to the first user in aggregate or individual form.

The details of one or more embodiments of the present invention are set forth in the accompanying drawings and the description below. Other features and advantages will become apparent from the description and the drawings.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a system-level network diagram of an opinion system for facilitating and aggregating surveys and opinions in accordance with one embodiment of the present invention;

FIG. 2 depicts a block diagram of a general computer system, [which is capable of being used in connection with the opinion system depicted in FIG. 1] in accordance with another embodiment of the present invention;

FIG. 3 depicts a flowchart of a method for facilitating and aggregating surveys and opinions regarding multimedia data in connection with a purchasable good/service in accordance with yet another embodiment of the present invention;

FIG. 4 depicts a flowchart of a method for facilitating and aggregating surveys and opinions regarding multimedia data in connection with a purchasable good/service in accordance with yet another embodiment of the present invention;

FIG. 5 depicts a flowchart of a method for facilitating and aggregating surveys and opinions from the perspective of a first user in accordance with an embodiment of the present invention;

FIG. 6 depicts a flowchart of a method for facilitating and aggregating surveys and opinions from the perspective of a first user in accordance with an embodiment of the present invention;

FIG. 7 depicts a flowchart of a method for facilitating and aggregating surveys and opinions from the perspective of a second user in accordance with the embodiments of the present invention;

FIG. 8 depicts a flowchart of a method for facilitating and aggregating surveys and opinions from the perspective of an administrator in accordance with the embodiments of the present invention;

FIG. 9 depicts a flowchart of a method for facilitating and aggregating surveys and opinions from the perspective of an administrator in accordance with the embodiments of the present invention;

FIG. 10 depicts a system level diagram of a community buying system for purchasable goods/ services in accordance with an embodiment of the present invention;

FIG. 11 depicts a flowchart of a method for facilitating a community buying system from the perspective of a buyer in accordance with one embodiment of the present invention;

FIG. 12 depicts a flowchart of a method for facilitating a community buying system from the perspective of a seller in accordance with one embodiment of the present invention; and

FIG. 13 depicts a flowchart of a method for facilitating a community buying system from the perspective of an administrator in accordance with one embodiment of the present invention.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean “including but not limited to.” To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

Embodiments of the present disclosure generally relate to a method and system for facilitating and aggregating surveys and opinions. More specifically, embodiments of the present invention relate to a method and system for facilitating and aggregating surveys and opinions with respect to multimedia data and image data in connection with a purchasable good/service.

As used herein, the term “purchasable good” refers collectively to any good or service or any product, item, or commodity, which is capable of being purchased, sold, acquired, or otherwise transferred in any fashion, utilized, bartered for, exchanged forin accordance with the embodiments of the present invention. Purchasable goods may include, but are not limited to, clothing, jewelry, homes, automobiles, or any other suitable product, item, or commodity, or the like. From the perspective of services, purchasable goods may include, but are not limited to professional services (e.g., medical, legal, etc.), personal services (e.g., dry cleaning, landscaping, etc.), shopping services (e.g., retail stores, department stores, wholesale stores, etc.), or the like. In certain embodiments, the definition of “purchasable good” may further include non-possessory objects, ideas, or persons, for example, candidates (e.g., political, professional, or the like), significant others (e.g., possible social dates, identity of boyfriend/girlfriend, or the like), recipes/instructions (e.g., food recipes, manuals, guides, or the like), designs/ideas (e.g., architectural designs, product designs, advertisements, inventions, or the like).

Also, as used herein, the term “multimedia data” refers to any type of data that may reasonably be construed as a media data type, including specifically, audio data (e.g., sound bites, music, or the like), visual data (e.g., photographs, graphics, videos, or the like), text data (e.g., as entered by a user from an input device), barcode data (e.g., as commonly found on product tags or labels), radio frequency identification (RFID) data, geographic and/or directional data (e.g., as reported from a Global Positioning System (GPS) or a preprogrammed routing source, often in the form of coordinates, or relationship positioning), or the like. As understood by the embodiments disclosed herein, any discussion of one particular form of multimedia data shall be inclusive of any other type of multimedia data as defined above.

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

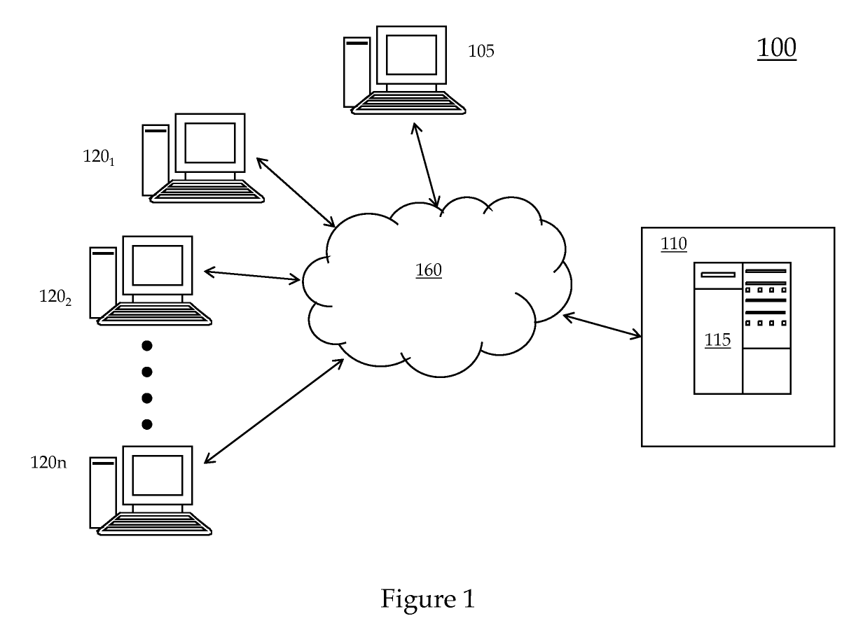

FIG. 1 depicts a basic system-level diagram of a survey and opinion system for purchasable goods in accordance with one embodiment of the present invention. The system 100 generally comprises at least a first user 105 and secondary users 120₁ and 120₂, each in communication with an administrator 110, generally hosting a central server 115, through a network 150. A survey and opinion inquiry in accordance with one or more embodiments of the present invention takes place over the network 150, which may comprise a global computer network, for example, the Internet.

Although FIG. 1 explicitly depicts three secondary users (labeled “User 2” 120₁, “User 3” 120₂, and “User N” 120_{N}), it should be appreciated that N represents any number of users feasible in accordance with embodiments of the present invention. For ease of reference, as used herein, each of the terms “second user” or “secondary user” may refer to any one or all of the users 120₁, 120₂, and 120_{N} within the system 100. Likewise, although FIG. 1 explicitly depicts only one first user 105, there may be more than one first user 105 in accordance with certain embodiments of the present invention. That is, in certain embodiments, multiple users may perform the same or similar functions as the first user 105. As understood by embodiments of the present invention, a user may include any person, business or entity, capable of participating in the system and methods disclosed herein.

The first user 105 generally has an interest in a purchasable good 140. The interest may be real or hypothetical, and may be regarding the purchase, sale, acquisition, rent, lease, disposal, creation, or the like, of the purchasable good 140. Alternatively, the interest may be regarding an attribute of the purchasable good 140. For example, an attribute may comprise a particular feature, element or design of the purchasable good 140. In other embodiments of the present invention, the interest may comprise a relationship between the purchasable good 140 and the first user 105, for example, the appearance of the purchasable good 140 in relation to the first user 105.

In certain embodiments, the first user 105 may be in physical possession or physical proximity of the purchasable good 140. Alternatively, the first user 105 may be in possession of or possess the location of certain electronic data regarding the purchasable good 140, for example, a website describing the purchasable good 140.

In a basic exemplary embodiment, within the system 100, a first user 105 may be capable of transmitting data regarding the purchasable good 140 to the administrator 110, using a mobile device. The mobile device in the context of this application may include, but is not limited to, an Apple iPhone, a Blackberry device, Personal Data Assistant (PDA) or the like, or may generally include a general purpose computer, as discussed below.

As explained above, the network 150 may comprise any network suitable for embodiments of the present invention. For example, the network 150 may be a partial or full deployment of most any communication/computer network or link, including any of, any multiple of, any combination of or any combination of multiples of a public or private, terrestrial wireless or satellite, and wireline networks or links. The network 150 may include, for example, network elements from a Public Switch Telephone Network (PSTN), the Internet, core and proprietary public networks, wireless voice and packet-data networks, such as 1G, 2G, 2.5G and 3G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

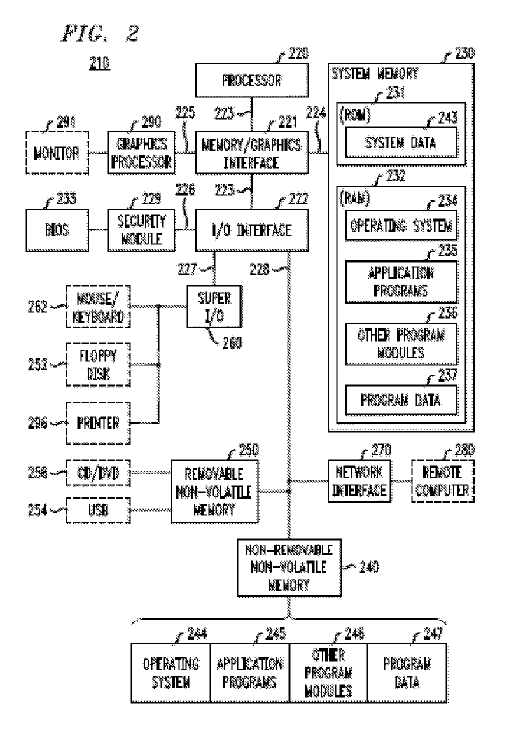

In accordance with one embodiment of the present invention, any of the administrator or users may comprise a general purpose computer, for example, as shown in the form of a computer 210 depicted in FIG. 2. As appreciated by embodiments fo the present invention, more practical devices, such as mobile devices, mobile telephones, or the like, are likely to be utilized than a general computer 210 for embodiments of the present invention. However, it is also appreciated there is a significant similarly in core components between a mobile device and a general computer 210. The following components are described for exemplary purposes only, and each component's mobile equivalent is also contemplated within embodiments of the present invention.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

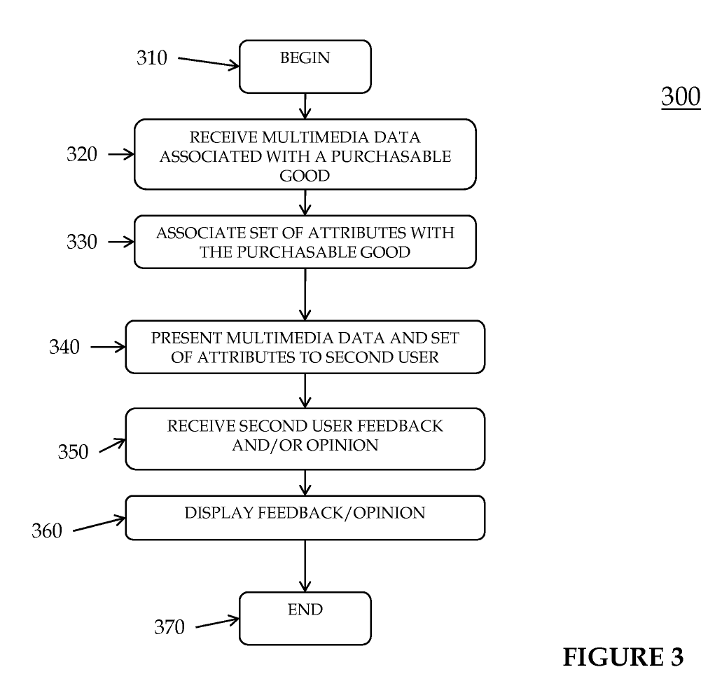

FIG. 3 depicts a flowchart of a method for facilitating and aggregating surveys and opinions in accordance with one embodiment of the present invention. For convenience, the method 300 is described with reference to system 100 of FIG. 1. The method 300 may be carried out within other system architectures as well.

The method 300 begins at step 310. At step 320, administrator 110 receives multimedia data associated with a purchasable good from a first user 105 via network 150. Multimedia data may include any data suitable for embodiments of the present invention, for example, image, video, sound, barcode, radio frequency identification (RFID), geographic and/or directional data. In one embodiment, the multimedia data comprises a digital photograph (e.g., a jpeg file) of a purchasable good 105. In such an embodiment, the purchasable good 140 may be displayed at a point of sale in a retail store, worn or carried (if applicable) by the first user 105, or the like. In many embodiments, the source of the data may be acquired from a component on the mobile device utilized by the first user 105 (e.g., camera phone).

At step 330, administrator 110 associates a set of attributes with the purchasable good 140. In accordance with one embodiment of the present invention, the set of attributes may include a question or a plurality of questions related to the purchasable good 140 generated by the first user 105 to be presented to a second user 120. It should be appreciated that the set of attributes may include any other information including, but not limited to, characteristics, parameters, and specifications of the purchasable good 140 selected by the first user 105.

In certain embodiments, however, step 330 provides the administrator 110 provides the set of attributes to be associated with the purchasable good. For example, in one such embodiment, the administrator 110 may associate a basic inquiry with each purchasable good 140 within the system 100. Exemplary questions may include “What do you think?,” “Like it?,” “Should I buy it?,” or the like.

At step 340, administrator 110, through utilization of executable instructions stored within the central server 115, presents the multimedia data associated with a purchasable good 140 and the set of attributes to a second user 120. The second user 120 may views the multimedia data and set of attributes associated with the purchasable good through its own computer device. In many embodiments, the second user 120 may access the multimedia data and set of attributes via a website or data portal, accessible through the network 160. A more detailed description of the user's ability to access such a website or data portal is discussed below.

At step 350, the second user 120 provides and the administrator 110 receives the second user's feedback and/or opinion related to the purchasable good via network 150. It should be appreciated that the second user's feedback and opinion may be in many formats including, but not limited to, user comments, votes, response, or the like. In many embodiments the nature of the second user's feedback and/or opinion will be largely dependent upon the nature of the multimedia data provided and the set of attributes associated therewith. For example, if a set of attributes is a question yielding a “yes” or “no” response, the feedback will likely be either a “yes” or “no” response. Similarly, if the set of attributes is a question prompting a numerical response (e.g., “How much would you pay for this?”), the feedback may likely comprise a specific numerical answer or written response (e.g., “$50.00” or “No idea what I would pay!”).

At step 360, the administrator 110 displays the second user's feedback and/or opinion to the first user 105. The second user's feedback and/or opinion 135 may be in individual or aggregate form. For example, in the case of a plurality of second users, the first user 105 may receive each of the plurality of second users' feedback individually, collectively, or a combination thereof.

The method 300 is concluded at step 370. However, it should be noted the method 300 may be repeated any number of times or for any number of reasons, e.g., for a multitude of users, periodically or as many times as users access the system 100.

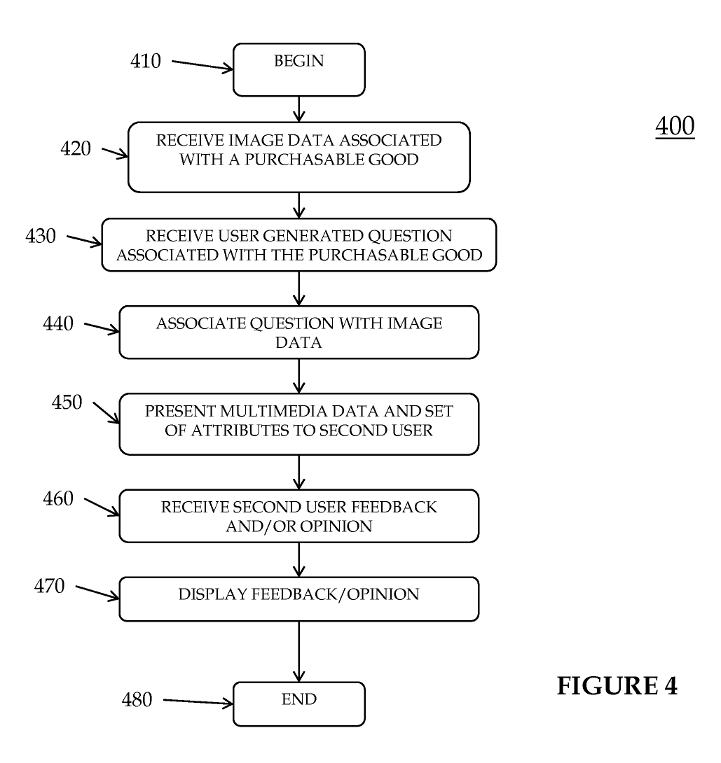

FIG. 4 depicts a flowchart of a method for facilitating and aggregating surveys and opinions with respect to image data associated with a purchasable good in accordance with yet another embodiment of the present invention. For convenience, the method 400 is described with reference to system 100 of FIG. 1. The method 400 may be carried out within other system architectures as well.

The method 400 begins at step 410. At step 420, administrator 110 receives image data associated with a purchasable good from a first user 105 via network 150. Image data may include any image, sound, or video data (collectively “image data”) type suitable for embodiments of the present invention, for example, picture files in any standard picture format. Exemplary suitable formats include, but are not limited to: JPEG, BMP, GIF, TIFF, PDF, MP3, MPEG, and the like.

The first user 105 may upload image data into system 100 using a mobile device or personal computer. Specifically, the first user 105 may upload to an image file already stored on the first user 105's mobile device or personal computer. In an alternative embodiment, the first user 105 may utilize a mobile device having a camera or suitable photograph acquisition means built therein, to obtain a picture file to upload to the administrator 110.

Whereas embodiments of the present invention generally comprise a purchasable good, the image data will generally represent an image of the particular purchasable good. For example, in one embodiment, where a first user 105 desires to purchase a pair of jeans (i.e., the purchasable good) from a store, the image data may comprise a photograph of the jeans. In accordance with various embodiments of the present invention, the image data may comprise a photograph of the jeans on the shelf, hanging on a rack, dressed on a mannequin, displayed on a third party, being worn by the first user 105, combinations thereof, or the like.

At step 430, administrator 110 receives a question generated by the first user 105 via network 150. The question may comprise any inquiry related to the purchasable good 140. With respect to the example discussed above, regarding the first user's desire to purchase jeans, the first user 105 may submit an inquiry regarding a second user's opinion of how the first user looks when wearing the jeans (e.g., “How do I look in these jeans?”).

At step 440, at the server 150, generally through a database and associated software (not shown), the administrator 110 associates the user generated question with the image data regarding the purchasable good.

Once the image data and user-generated question are associated with one another, at step 450, the administrator 110 presents the image data and user generated question to a second user 120 via the network 150. Once presented, the second user receives the image data and associated user-generated question. The second user is allowed to view the image data and associated user-generated question, and provide feedback and/or comments related to the purchasable good.

To continue with the above example, if the second user is presented with a photograph of the first user and the question “How do I look in these jeans?,” the second user may provide an opinionated comment, e.g., “You look great!,” a vote, e.g., a thumbs-up symbol, or similar type response. In many embodiments, the nature of the response can be controlled by either the administrator or the first user. For example, the administrator may first require a vote (e.g., thumbs-up or thumbs-down), which may be followed by a qualified comment.

At step 460, the administrator 110 receives the second user's feedback and/or opinion related to the purchasable good via the network 150. Optionally, at this step, the administrator 110 may verify and aggregate feedback from a plurality of second users. As used herein, final purchasable good data comprises second user feedback and/or opinion that has been verified by the administrator 110.

Similar to step 360 above, at step 470, the administrator 110 displays the second user's feedback and/or opinion to the first user 105. The second user's feedback and/or opinion 135 may be in individual or aggregate form. For example, in the case of a plurality of second users, the first user 105 may receive each of the plurality of second users' feedback individually, collectively, or a combination thereof.

In alternative embodiments, the administrator 110 may further display suggestions or extrapolated comments to the first user 105. For example, if the consensus of the second users 120 is that “the jeans look great!,” the administrator may provide a suggestion such as “Your friends voted ‘YES’ for these jeans! They may also like ______ as well!,” and provide a link, image or description of the suggested product. Similarly, for example, if the consensus of the second users 120 is that “I don't like those on you!,” the administrator 110 may provide a suggestion such as “Since your friends didn't like those jeans, you should see what they think about ______.” In accordance with many embodiments of the present invention, such suggestions are limitless in view of the nature of the comments, feedback or the like, aggregated from the second users 120.

The method 400 is concluded at step 480. However, it should be noted the method 400 may be repeated any number of times or for any number of reasons, e.g., for a multitude of users, periodically or as many times as users access the system 100.

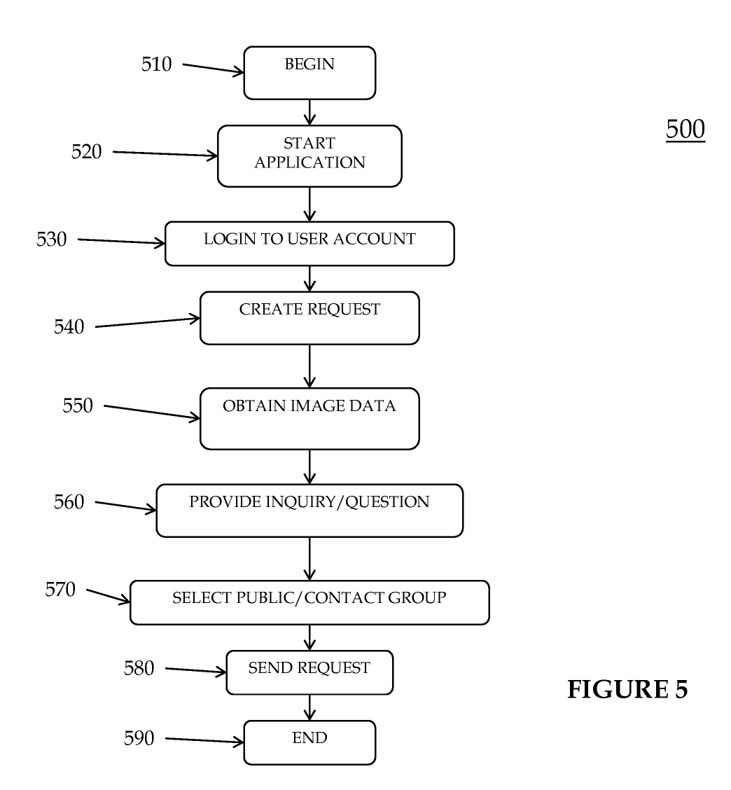

FIG. 5 depicts a flowchart of a method for facilitating and aggregating surveys and opinions from the perspective of a first user in accordance with an embodiment of the present invention. The method of 500 begins at step 510. At step 520, a first user 105 enables a software application on a mobile device or personal computer. The software application generally comprises executable instructions to enable the first user to engage in the methods and systems disclosed herein.

In some embodiments, the software application is accessible to the first user through the network 150, e.g., through a website available on the Internet. In other embodiments, the first user's mobile device may be preprogrammed with such software application upon purchase or obtaining the mobile device. In further embodiments, the software application is accessible via a downloadable application. For example, in one embodiment, wherein the first user is in possession of an Apple iPhone, the software application may be a downloadable “app,” available through the Apple App Store, commercially available for any iPhone.

At step 530, the first user 105 logs into a user account, generally stored within a database on the central server 115, hosted by the administrator 110. The login procedure may comprise basic security measures, for example, a standard username and password request, biometric identity confirmation, voice recognition, or the like.

In certain embodiments, when a first user 105 is utilizing the system 100 for the first time, an account may have to be created on the database for future access. In accordance with embodiments of the present invention, a user account may be created using any suitable means in the industry. For example, a user account may require a first user to provide demographic, personal and/or geographic data, along with a desired username and password combination. For additional security to the integrity of the system 100, verification of user account information may also be provided in certain embodiments. For example, certain embodiments may require the use of email confirmation responses, SMS message response, or the like, to activate an account before use.

Similarly, there may be instances where a first user 105 forgets a username and/or password. Embodiments of the present invention may also require the use of safety/security features for username or password recovery, including the use of security questions, automated email with forgotten information, password reset, SMS-based password recovery, combinations thereof, or the like.

At step 540, the first user 105 elects to create a request. A request is utilized herein to identify a first user's desire to obtain opinions/feedback regarding a purchasable good. Often, the election to create a request is not undertaken until the first user has selected the purchasable good, is in possession of multimedia data regarding the purchasable good, and has identified at least one of a set of attributes to associate with the purchasable good.

At step 550, the first user 105 uploads multimedia data to the administrator 110 using a mobile device. As discussed above, the first user 105 may upload stored multimedia data or may obtain multimedia data at or around the time of upload, e.g., using a camera phone or similar device.

In one particular embodiment of the present invention, the first user 105 may utilize a camera phone, an infrared scanner or similar input device to obtain data from a source identifier, e.g., a barcode, RFID tag or the like, associated with a purchasable good. For example, an individual interested in purchasing a product at a retail store can take a photograph of a hangtag barcode using a mobile device. Using an integrated software application, the barcode may be deciphered and a product identity obtained. With the product identity known, the first user may locate information regarding the product using a search engine, a software application or the like, and utilize stored images associated therewith as the multimedia data for step 550.

At step 560, the first user 105 creates a question related to the purchasable good. The question may comprise any inquiry related to the purchasable good 140. With respect to the example discussed above, regarding the first user's desire to purchase jeans, the first user 105 may submit an inquiry regarding a second user's opinion of how the first user looks when wearing the jeans (e.g., “How do I look in these jeans?”). Once sent to the administrator 110, the multimedia data and question are associated with one another within the central server 115, generally on a database.

At step 570, the first user 105 selects the identity of the second user 120 from a predetermined list. As such, the first user 105 can limit the number of second users who receive the survey and/or opinion request. The first user 105 may select certain individuals or groups of individuals (e.g., “friends”), or anyone registered with system 100 (e.g., open to the public). In an alternative embodiment of the present invention, the first user 105 may send a short message service (“SMS”) invitation to any unregistered users of system 100. Once registered, the previously unregistered second user may be included on the list of predetermined/selected second users.

At step 580, the first user 105 confirms the multimedia data, question, and second user(s), and submits the survey and/or opinion request to the administrator 115. The method 500 is concluded at step 590. However, it should be noted the method 500 may be repeated any number of times or for any number of reasons, e.g., for a multitude of users, periodically or as many times as users access system 100.

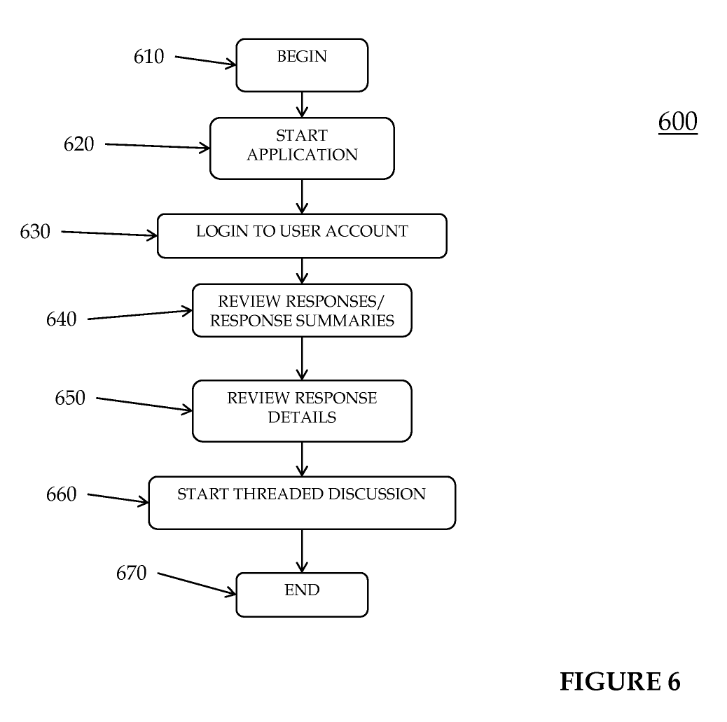

In accordance with another embodiment of the present invention, FIG. 6 depicts a flowchart for a method for the first user 105 to review responses to a survey or opinion request. The method of 600 begins at step 610. At step 620, a first user 105 enables a software application on a mobile device or personal computer. The software application generally comprises executable instructions to enable the first user to engage in the methods and systems disclosed herein, and may comprise any format, as discussed above.

At step 630, the first user 105 logs into a user account, generally stored within a database on the central server 115, hosted by the administrator 110. At step 640, the first user 105 elects to review feedback from second users regarding a response to a survey and/or opinion request. As indicated in the other embodiments of the present invention, the second user's feedback may include, but is not limited to, comments and/or votes regarding a purchasable good.

At step 650, the first user 105 can elect to view the second user's feedback and/or opinion 135 in an individual or aggregated format. For example, in the case of a plurality of second users, the first user 105 may receive each of the plurality of second users' feedback individually, collectively, or a combination thereof.

At step 660, the first user 105 may optionally begin a threaded discussion (e.g., responding to a second user's feedback) or sending a new request (e.g., regarding a related or new purchasable good). It should be appreciated that if the first user 105 creates a threaded discussion and submits an entry therein, the second user is provided with an option of responding to the first user 105's submitted entry. The first user 105 and second user may continue to post entries for as long as the first user 105 or second user desires.

The method 600 is concluded at step 670. However, it should be noted the method 600 may be repeated any number of times or for any number of reasons, e.g., for a multitude of users, periodically or as many times as users access system 100.

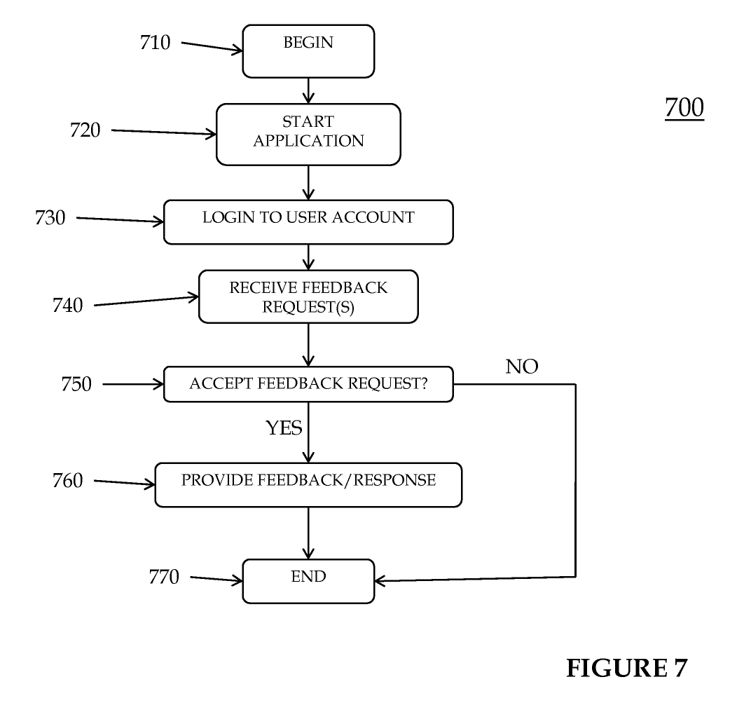

FIG. 7 depicts a flowchart of a method for facilitating and aggregating surveys and opinions from the perspective of a second user in accordance with the embodiments of the present invention. For convenience, the method 700 is described with reference to system 100 of FIG. 1. The method 700, however, may also be carried out with other system architectures as well.

The method 700 begins at step 710. At step 720, a second user 120 enables a software application on a mobile device or personal computer. The software application generally comprises executable instructions to enable the first user to engage in the methods and systems disclosed herein, and may comprise any format, as discussed above.

At step 730, the second user 120 logs into a user account, generally stored within a database on the central server 115, hosted by the administrator 110. At step 740, the second user 120 is notified of any pending feedback, if available, and may elect to engage in the request.

If pending requests are available, at step 750, the second user 120 selects whether the request will be accepted or denied. At this stage, the second user 120 may be able to view the entire request, the sender of the request, a summary of the nature of the purchasable good, or the like. If the second user 120 denies the feedback request(s), the method concludes at step 770.

If the second user 120 accepts the feedback request(s), at step 760, the second user 120 provides feedback to a purchasable good selected by the first user 105 as described in the other embodiments of the present invention. The second user's feedback may include, but is not limited to, user comments and votes related to the purchasable good 140.

At step 770, the method 700 ends. However, it should be noted the method 700 may be repeated any number of times or for any number of reasons, e.g., for a multitude of users, periodically or as many times as users access system 100.

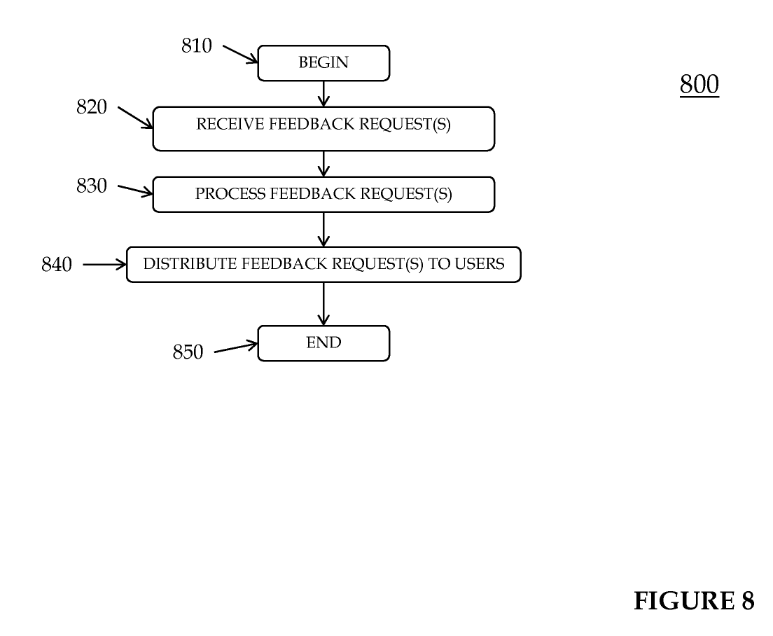

FIG. 8 depicts a flowchart of a method for facilitating and aggregating surveys and opinions from the perspective of an administrator in accordance with the embodiments of the present invention. Specifically, FIG. 8 describes an exemplary method for sending feedback requests to the second user. For convenience, the method 800 is described with reference to system 100 of Figure. The method 800, however, may also be carried out with other system architectures as well.

The method 800 begins at step 810. At step 820, administrator 110 receives feedback requests the first user 105. At step 830, administrator 110 processes all of the available feedback requests and stores the requests in any appropriate computer storage media known in the art including, but not limited to, volatile and/or nonvolatile memory such as read only memory (ROM) 231 and random access memory (RAM) 232.

At step 840, administrator 110 distributes each available feedback request(s) stored in memory to the appropriate second user(s) as specified by the first user 105. The method 800 is concluded at step 850.

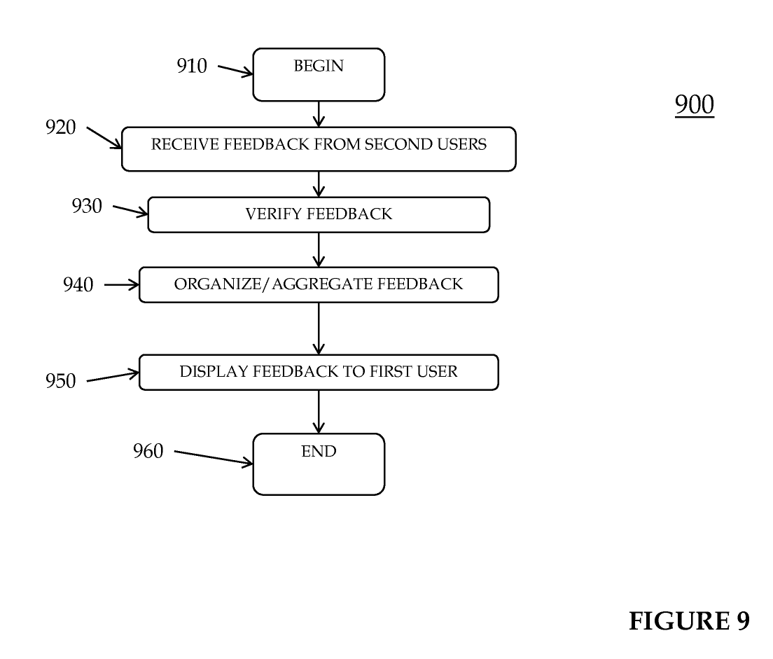

FIG. 9 depicts a flowchart of a method for facilitating and aggregating surveys and opinions from the perspective of an administrator in accordance with the embodiments of the present invention. The method 900 begins at step 910. At step 920, administrator 110 receives feedback from the second user 120. At step 930, administrator 110 verifies the feedback that it receives from the second user or plurality of second users. Verifying the feedback may include, but is not limited to, confirming that each second user voted or submitted a comment, or checking to see if the user comments satisfy certain parameters (i.e., a character limit).

At step 940, administrator 110 organizes and aggregates the second user's feedback. Since a first user 105 may present a feedback request to a plurality of second users, in some embodiments aggregation is necessary to combine all of the second users' feedback for a single feedback request. In such types of embodiments, the administrator's organization of feedback is essential to the efficiency and well-being of system 100.

At step 950, administrator 110 displays the final purchasable good data 140 to the first user 105. The first user 105 can elect to view the second user's feedback and/or opinion 135 in an individual or aggregated format. For example, in the case of a plurality of second users, the first user 105 may receive each of the plurality of second users' feedback individually, collectively, or a combination thereof.

The method 900 is concluded at step 960. However, it should be noted the method 900 may be repeated any number of times or for any number of reasons, e.g., for a multitude of users, periodically or as many times as users access system 100.

In some alternative embodiments of the present invention, the system 100 notes the first user's location using a global positioning system (“GPS”) device located in the first user's mobile device. By possessing knowledge of the first user's location, the administrator 110 may uses the location information to provide the first user 105 with additional purchase information related to the purchasable good. Additional purchase information may include, but is not limited to, directions to stores selling the first user's desired purchasable good and local stores selling the first user's desired purchasable good.

For example, consistent with the other embodiments of the present invention, a first user 105, using a mobile device, may input image information into system 100 by taking a picture or scanning a barcode of a pair of jeans at a department store. The mobile device's GPS device will record the first user's location information. The first user's mobile device will then transmit the location information to the administrator 110 via network 150. The administrator 110 will use the first user's location information to lookup other local stores that carry the same pair of jeans. The administrator 110 may then display the names of the stores carrying the same pair of jeans, optionally with the sale price, on the first user's mobile device.

In another embodiment of the present invention, the administrator 110 may display price ranges from multiple vendors, and ratings from consumers and experts regarding the purchasable good.

In yet another embodiment of the present invention, administrator 110 may display in-store coupons, offers, and circulars related to the purchasable good based on the first user's location. As such, the first user 105 may be presented with coupons, offers, and circulars for stores that are located close to the first user's position.

In yet another embodiment of the present invention, administrator 110 records the syntax of conversations between the first user 105 and second user 120 (e.g., threaded discussion), the multimedia data, and the first user 105 location by way of a mobile device's GPS. The administrator 110 may analyze all of the recorded data and present to the first user 105 on his mobile device a list of relevant stores based on the recorded data.

In yet another embodiment of the present invention, the first user 105 takes a picture or scans a barcode of a purchasable good using a mobile device. The picture data and/or barcode data is uploaded to an online website such as Amazon.com via network 150. Next, the system 100 returns to the first user 105 the purchasable good on the mobile device. It should be appreciated that the first user 105 may purchase the purchasable good that is returned on the mobile device using any known purchasing means including, but not limited to, one-click purchasing, a credit card transaction, electronic funds transfer, etc.

In yet another alternative embodiment of the present invention, the second user may get paid for providing feedback to the first user 105. It should be appreciated that the second user may be paid in a number of ways including, but not limited to, on a per opinion/comment basis or according to the number of first user 105s that are receiving opinions.

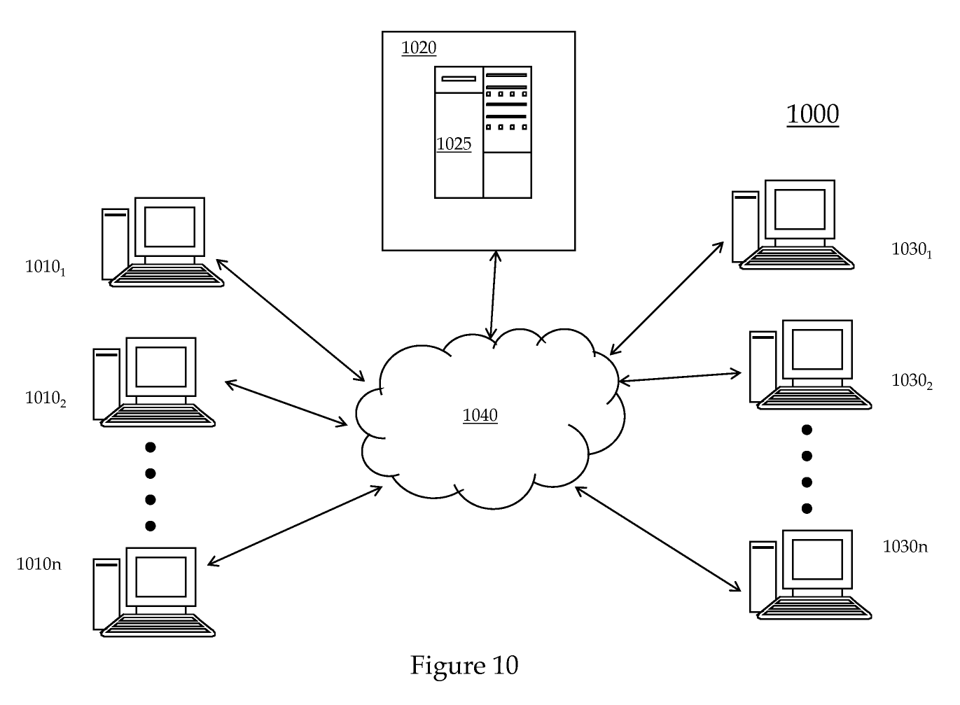

FIG. 10 depicts a basic system-level diagram of a community buying system 1000 for purchasable goods in accordance with yet another embodiment of the present invention. The system 1000 generally comprises at least a first seller 1010₁ and a first buyer 1030₁, each in communication with an administrator 1020, having a central server including a database, through a network 1040. A community buying event in accordance with one or more embodiments of the present invention takes place over the network 1040, which may comprise a global computer network, for example, the Internet.

Although FIG. 10 explicitly depicts two sellers (labeled “Seller 1” 1010₁ and “Seller 2” 1010₂) and two buyers (labeled “Buyer 1” 1030₁ and “Buyer 2” 1030₂), it should be appreciated that n represents any number of users feasible in accordance with embodiments of the present invention. For ease of reference, as used herein, each of the terms “seller” or “buyer” may refer to any one or all of the sellers 1010₁, 1010₂, or 1010ₙ and buyers 1030₁, 1030₂, or 1030ₙ. As understood by embodiments of the present invention, each seller or buyer may include any person, business or entity, capable of participating in the system and methods disclosed herein, and generally in possession of a mobile device or personal computer.

The present system 1000 facilitates an aggregating tool for group buying utilizing top-of-file position for buyers 1010 and sellers 1030 within the system 1000, similar to the methodology provided by NASDAQ Level 2 services for exchange participants. By utilizing a top-of-file position, the administrator 1020 can view an organized list of sale prices and quantities from sellers 1030 within the system, and an organized list of purchase prices from the buyers. The aggregating tool allows for the aggregation of both implicit and explicit intent of both buyers 1010 and sellers 1030 within the system 1000, and may gauge a market for a particular purchasable good. The aggregating tool may make the market for the particular purchasable good transaparent to both the buyers and sellers, and facilitates the aggregation (e.g., platform, niche market placement, social parameters, shopping, category sites, or the like), processing (e.g., matching, financial processes, or the like), distribution of potential or actual transaction(s) (e.g., warehouse concerns, product tracking, or the like) and metrics (e.g., market analysis, demand flow, or the like).

The sellers 1010 may comprise any person or entity, generally in possession of at least one purchasable good wherein the seller wishes to sell the purchasable good. Generally, the seller wishes to sell purchasable good in bulk quantities. However, the seller may sell a single item of a purchasable good while using the system.

The buyers 1030 may comprise any person or entity, having a desire to acquire a particular purchasable good. The buyers 1030 may be generally unknown to one another, and may be unknowingly linked to one another through the administrator 1020, by the common element of a similar desire to acquire the same purchasable good.

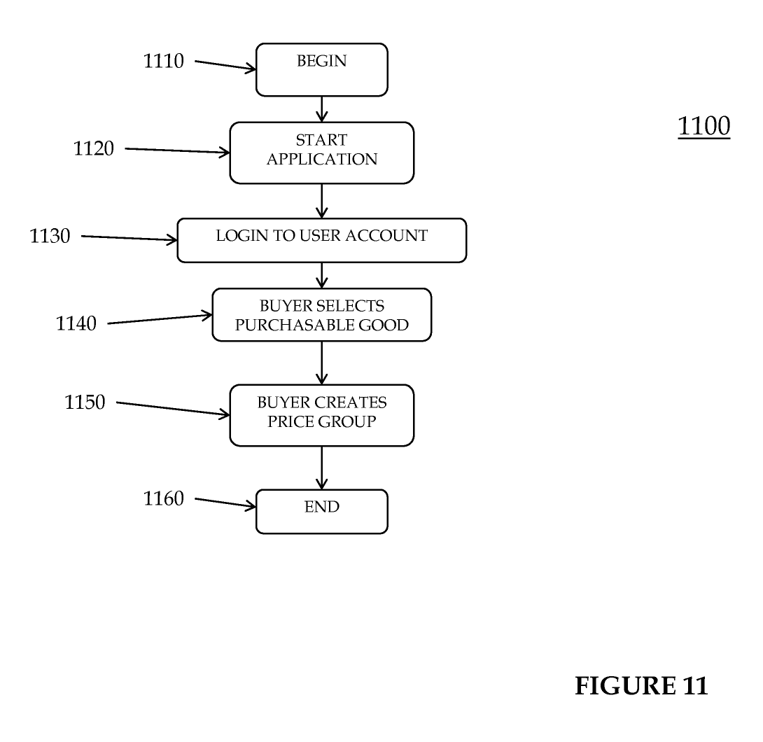

FIG. 11 depicts a flowchart of a method for facilitating a community buying system from the perspective of a buyer in accordance with one embodiment of the present invention. The method 1100 begins at step 1110. At step 1120, a buyer 1030 enables a software application on a mobile device or personal computer. The software application generally comprises executable instructions to enable the first user to engage in the methods and systems disclosed herein.

At step 1130, the buyer 1030 logs into the system using any type of login procedure disclosed herein. At step 1140, the buyer 1030, using a mobile device or personal computer, identifies a desired purchasable good. Such identification may take place via user selection on a website or public shopping forum, source identifier scans (e.g., barcode or RFID as discussed above), or the like.

At step 1150, the buyer 1030 inputs a desired purchase price and quantity of the purchasable good to be purchased. It should be appreciated that each of the buyers 1030 within the system 1000 individually input price and quantity information to the administrator 1020. The method 1100 is concluded at step 1160.

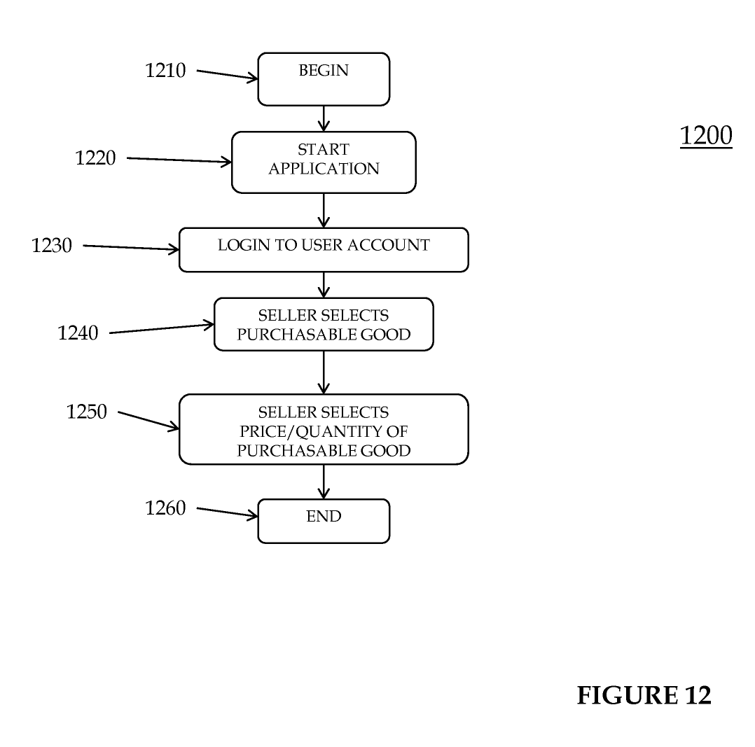

FIG. 12 depicts a flowchart of a method for facilitating a community buying system from the perspective of a seller in accordance with one embodiment of the present invention. The method 1200 begins at step 1210. At step 1220, a seller 1010 enables a software application on a mobile device or personal computer. The software application generally comprises executable instructions to enable the first user to engage in the methods and systems disclosed herein.

At step 1230, the seller 1010 logs into the system using any type of login procedure disclosed herein. At step 1240, the seller 1010 selects a purchasable good for sale, in the possession of seller 1010.

At step 1250, the seller 1010, using a mobile device or personal computer, inputs a sale price of the purchasable good and a quantity of the purchasable good to be sold. In many embodiments, the quantity to price may be slidable scale, such that the seller 1010 may offer a lower sale price for a larger quantity. Embodiments of the present invention allow the seller 1010 to provide such information as a relationship, rather than hard figures. The method 1200 is concluded at step 1260.

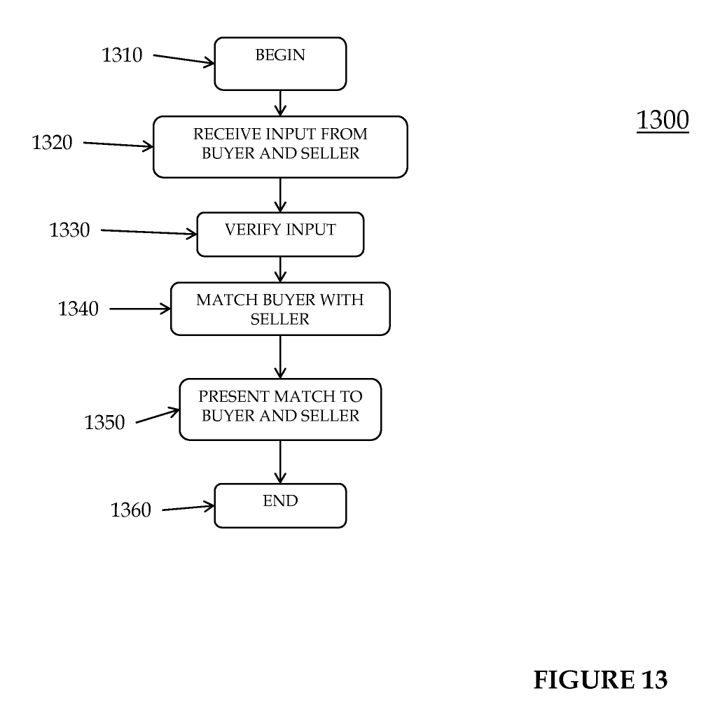

FIG. 13 depicts a flowchart of a method for facilitating a community buying system from the perspective of an administrator in accordance with one embodiment of the present invention. The method 1300 begins at step 1310. At step 1320, the administrator 1020 receives purchasable good data from the seller 1010 and the buyer 1030, as discussed in steps 1150 and 1250, respectively.

At step 1330, the administrator 1020 verifies the purchasable good data from the buyers 1030 and sellers 1010. Verifying the purchasable good data may include, but is not limited to, confirming that each seller or buyer inputted at least one parameter (e.g., purchasable good selection, price range, or quantity of purchasable goods to be sold).

At step 1340, the administrator 1020 utilizes a top-of-file position methodology to match sellers with buyers according to similar criteria. Similar to the embodiment discussed above, the aggregating tool allows for the aggregation of both implicit and explicit intent of both buyers 1010 and sellers 1030 within the system 1000, and may gauge a market for a particular purchasable good. The aggregating tool may make the market for the particular purchasable good transaparent to both the buyers and sellers, and facilitates the aggregation (e.g., platform, niche market placement, social parameters, shopping, category sites, or the like), processing (e.g., matching, financial processes, or the like), distribution of potential or actual transaction(s) (e.g., warehouse concerns, product tracking, or the like) and metrics (e.g., market analysis, demand flow, or the like).

At step 1350, the administrator 1020 provides the buyer and seller notification of the buyer/seller match. It should be appreciated that the notification may include any reasonable means of notifying a party including, but not limited to, email notification, text message, telephone call, or the like.

The method 1300 is concluded at step 1360. However, it should be noted the method 1300 may be repeated any number of times or for any number of reasons, e.g., for a multitude of users, periodically or as many times as users access system 1000.

In an alternative embodiment of the present invention, the buyer 1030 has the option to purchase the purchasable good using the buyer's mobile device or personal computer using any known purchasing means in the art including, but not limited to, one-click purchasing, a credit card transaction, electronic funds transfer, etc.

In an alternative embodiment of the present invention, the buyer 1030 or seller 1010 may use a mobile device or personal computer to create a survey and/or opinion request to send to another user as described in the other embodiments of the present invention. For example, a buyer 1030 may log into system 1000, select a purchasable good, and submit an opinion request along with an image of the purchasable good to other users asking whether the buyer should purchase the good. In yet another alternative, a seller 1010 may login to system 1000, select a purchasable good, and submit an opinion request along with an image of the purchasable good to other users asking whether the seller should sell the purchasable good.

While the foregoing is directed to embodiments of the present invention, other and further embodiments of the invention may be devised without departing from the basic scope thereof. Furthermore, whereas the multitude of embodiments disclosed herein each provide a variety of elements within each embodiment, it should be appreciated any combination of elements from any combination of embodiments is well within the scope of further embodiments of the present invention.

What is claimed is:

1. A method for facilitating and aggregating surveys and opinions comprising:
receiving at a central server, from a first user, multimedia data associated with a purchasable good;
associating a set of attributes with the purchasable good at the central server;
presenting the multimedia data associated with the purchasable good and the set of attributes to a second user;
receiving feedback reflective of the second user's opinion based on the multimedia data associated with the purchasable good and the set of attributes; and
displaying the feedback to the first user.

2. The method of claim 1, wherein the multimedia data comprises at least one of visual data and audio data.

3. The method of claim 1, wherein the second user comprises at least one of a mobile device or a personal computer.

4. The method of claim 1, wherein the first user 105 selects the identity of the second user from a predetermined list.

5. The method of claim 1, wherein the set of attributes further comprises a question generated by the user.

6. The method of claim 5, wherein the feedback further comprises a second user's vote in response to the question.

7. The method of claim 1, wherein displaying the feedback further comprises displaying the result in real-time.

8. The method of claim 1, wherein displaying the feedback further comprises displaying at least one of store coupons, offers, or circulars related to the purchasable good.

9. The method of claim 1, wherein displaying the feedback further comprises displaying a list of stores carrying the purchasable good wherein the stores are close to the first user 105's location.

10. The method of claim 1, further comprising displaying to the first user 105 a price of the purchasable good and allowing the first user 105 to purchase the purchasable good using at least one of a mobile device or personal computer.

11. A method for facilitating and aggregating surveys and opinions, the steps comprising:
receiving from a first user, image data associated with a purchasable good at a central server;
receiving a question generated by the first user;
associating the question with the purchasable good at the central server;
presenting the image data associated with the purchasable good and the question to a second user;
receiving feedback reflective of the second user's opinion based on the image data associated with the purchasable good and the question; and
displaying the feedback to the first user.

12. The method of claim 11, wherein the image data comprises an uploaded photo or a new photo taken by a camera.

13. The method of claim 11, wherein the second user comprises at least one of a mobile device or a personal computer.

14. The method of claim 11, wherein the first user 105 selects the identity of the second user from a predetermined list.

15. The method of claim 11, wherein displaying the feedback further comprises displaying at least one of store coupons, offers, or circulars related to the purchasable good.

16. The method of claim 11, wherein displaying the feedback further comprises displaying a list of stores carrying the purchasable good wherein the stores are close to the first user 105's location.

17. The method of claim 11, further comprising displaying to the first user 105 a price of the purchasable good and allowing the first user 105 to purchase the purchasable good using at least one of a mobile device or personal computer.

18. A system for facilitating and aggregating surveys and opinions comprising:
a central server, accessible via a global computer network comprising a tangible computer readable medium comprising program instructions, wherein the program instructions are computer-executable to implement:
receiving from a first user, multimedia data associated with a purchasable good at a central server;
associating a set of attributes with the purchasable good at the central server;
presenting the multimedia data associated with the purchasable good and the set of attributes to a second user;
receiving feedback reflective of the second user's opinion based on the multimedia data associated with the purchasable good and the set of attributes; and
displaying the feedback to the first user in aggregate or individual form.

19. The system of claim 18, wherein the second user comprises at least one of a mobile device or a personal computer.

20. The system of claim 18, wherein the set of attributes further comprises a question generated by the user.
